(19) United States
(12) Patent Application Publication
(10) Pub. No.: US 2008/0238228 A1
(43) Pub. Date: Oct. 2, 2008

(54) MAGNETIC SHAFT OF A COOLING FAN

(75) Inventors: Liang-Sheng Chang, Chu Pei City (TW); Tien-Chin Wu, Chu Pei City (TW)

Correspondence Address: EGBERT LAW OFFICES, 412 MAIN STREET, 7TH FLOOR, HOUSTON, TX, 77002, US

(73) Assignee: FORCECON TECHNOLOGY Co., Ltd., Chu Pei City (TW)

(21) Appl. No.: 11/691,189

(22) Filed: Mar. 26, 2007

(51) Int. Cl. H02K 7/00; H02K 5/16; F04B 17/00

(52) U.S. Cl. 310/90; 417/354; 310/67 R; 417/423.12

(57) ABSTRACT

The present invention provides an improved structure of the magnetic shaft of a cooling fan. A magnetic attraction component is comprised of a magnetic ring, a magnetic inductive bottom board, and a magnetic inductive ring. The magnetic field generated by the magnetic ring is guided from the upper and lower side by the magnetic inductive ring and the magnetic inductive bottom board respectively, so that the range of magnetic field scattered by the magnetic ring is effectively and reliably guided and suppressed. The range of the magnetic field is reduced to the smallest possible, and interference with other components is minimized within the cooling fan, working stability and quality of the cooling fan being enhanced.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a cooling fan, and more particularly to an innovative cooling fan with an improved structure of its magnetic shaft.

2. Description of Related Art Including Information Disclosed Under 37 CFR 1.97 and 37 CFR 1.98.

A cooling fan is generally comprised of a stator, a rotor, and a fan configured on the rotor. The rotor is fitted through a shaft on the bearing part of the axial tube unit at the center of the stator. When the rotor rotates, the rotary movement of the fan blades will generate a burble, and the air flow will generate a counteracting force pulling the fan blades and the rotor in the axial direction, resulting in axial vibration, instability as well as increased noise during rotation of the rotor shaft. To solve this problem, in later developments, the industry introduced a new cooling fan structure with reinforced positioning of the rotor shaft during rotation. A prior art structure similar to that of the present invention is shown in FIG. 1. In this structure, a magnet 02 is configured on the bottom end of the axial tube of the stator 01. The top surface of the magnet supports the bottom end of the shaft 04 of the rotor 03, and generates an axial attraction force to stable the rotor 03; however, it is discovered that such prior art structures still have problems during actual operation.

For example, a magnetic field W (as shown in FIG.2) will be generated around the magnet 02. As the size of the whole cooling fan may be very small when it is applied in some task machines, and even if the range of magnetic field scattered by the magnet 02 is not large, it will affect the peripheral components. In particular, within the cooling fan structure, there may often be a Holtz component, which is a magnetic sensing component. Hence, the magnetic field generated by the magnet 02 on the bottom end of the above-mention axial tube will very likely interfere with the operation of the Holtz component, and will consequently affect the normal and stable operation of the entire cooling fan.

Also, as the bottom end of the shaft 04 of the rotor 03 is directly pivoted on the top surface of the magnet 02, and as ordinary magnetic materials are weaker and less resistant to abrasion than metal, the top surface of the magnet 02 will have a concave shape after a certain period of operation of the shaft 04 of the rotor 03. As a consequence, the rotor 03 will deviate downwards and lose the accuracy of its configuration state, affecting the normal operation of the rotor. Therefore, such a structure is not durable and cannot meet the demands of the users.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention is an innovative and unique structure, in which the magnetic attraction component 40 is made up of a magnetic ring 41, a magnetic inductive bottom board 42, and a magnetic inductive ring 43. Compared to prior art, through guiding in the upward and downward directions by the magnetic inductive ring 43 and the magnetic inductive bottom board 42, the present invention has a range of magnetic field W2 generated by the magnetic ring 41 that is effectively and reliably guided and suppressed. The range of the magnetic field W2 is reduced to the smallest possible, and the interference with other components is minimized within the cooling fan. The working stability and quality of the cooling fan are also enhanced.

With the unique structure of the present invention, the bottom end 121 of the shaft 22 is pivoted on the top of the magnetic inductive bottom board 42. The magnetic inductive bottom board 42 is made of metal materials harder than magnet. As a consequence, the magnetic inductive bottom board 42 can bear the abrasion of the bottom end 121 of the shaft 22 for a longer period while maintaining a level surface status. Abrasion resistance, durability and longer lifespan constitute the advancements of the present invention.

The present invention can generate new results. For example, through the ring-shaped space configured between the ring hole 410 of the magnetic ring 41 and the bottom section 221 of the shaft 22, an oil storage space 50 is defined. The oil storage space 50 can store the oil that lubricates the bearing 12 and maintain the lubricating effect for a long period.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a cross-sectional view of the prior art structure.

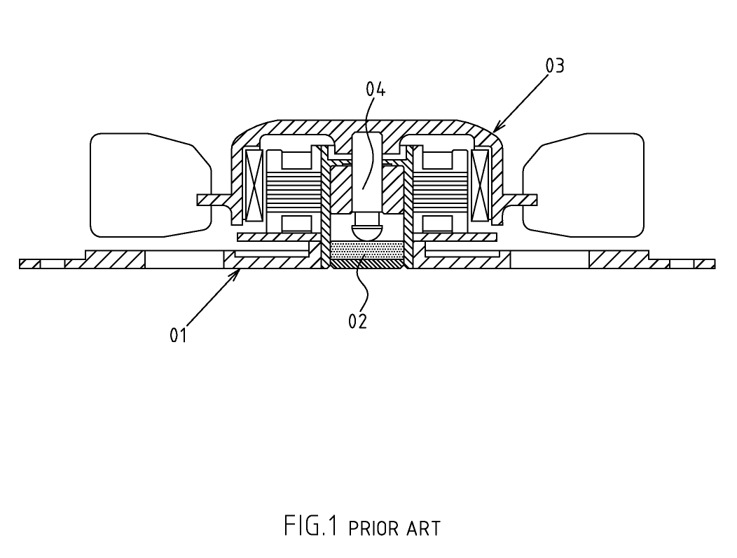

FIG. 2 shows an isolated schematic view of the magnetic field generated by the magnet in the prior art structure.

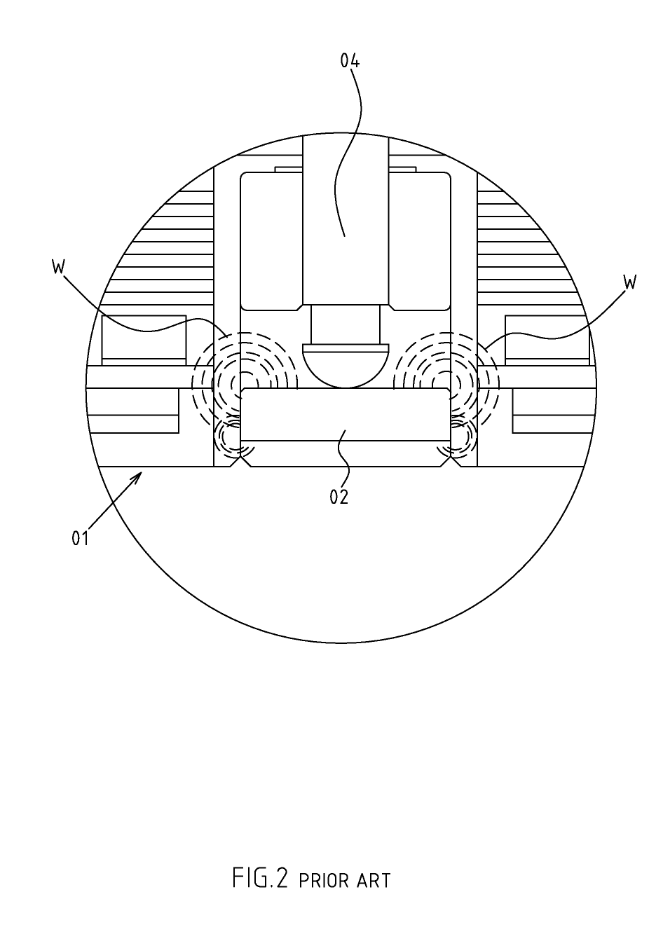

FIG. 3 shows another cross-sectional view of the entire structure of the cooling fan in the present invention.

FIG. 4 shows an isolated schematic view of the structure of the present invention.

FIG. 5 shows an exploded perspective view of the local structures in the present invention.

FIG. 6 shows an isolated schematic view of the magnetic field generated by the magnetic ring in the present invention.

FIG. 7 shows an isolated cross-sectional view of another embodiment of the structure of the present invention.

FIG. 8 shows an isolated cross-sectional view of still another embodiment of the structure of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

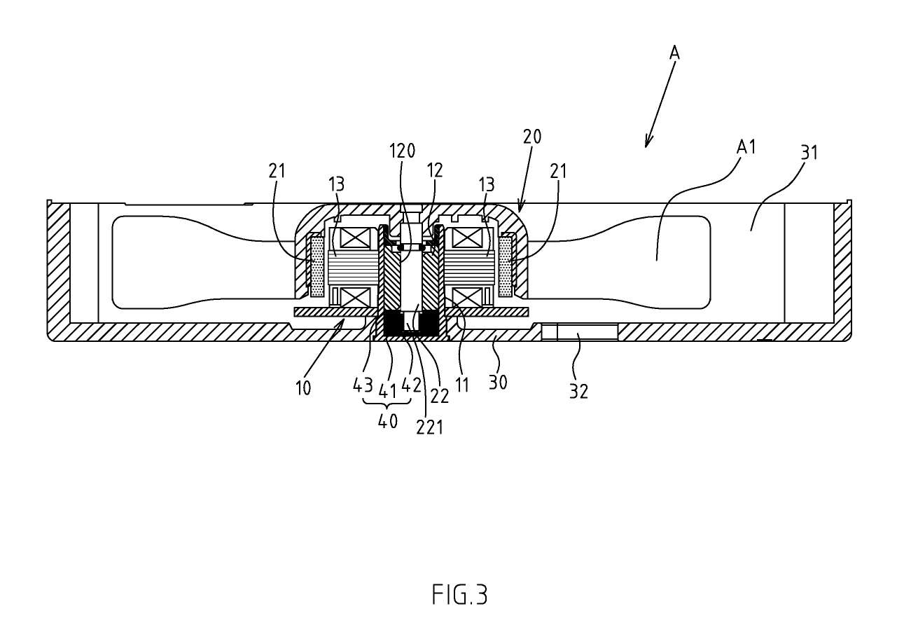

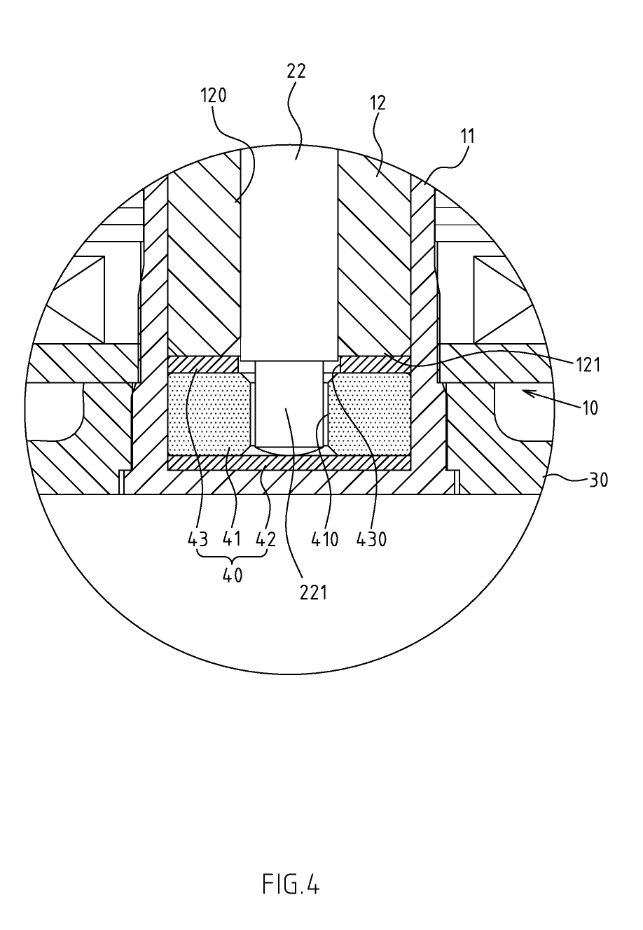

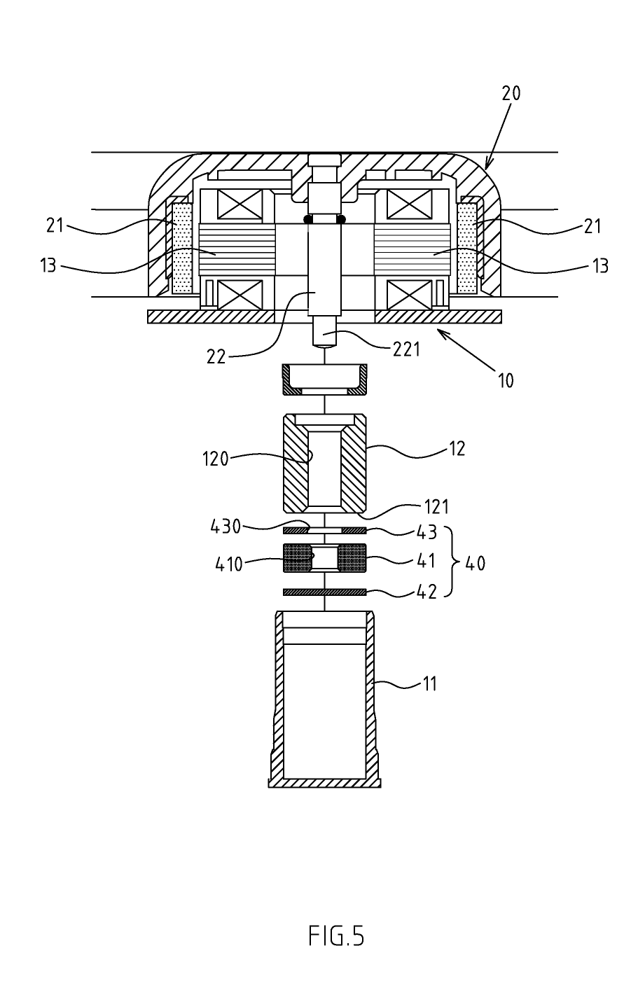

FIGS. 3-6 show the preferred embodiments of the improved structure of the magnetic shaft of cooling fan in the present invention. Such embodiments are for descriptive purpose only. The patent application is not restricted to these exact structures.

The cooling fan is comprised of a stator 10, a rotor 20 and an enclosure 30. The cross-section of the enclosure 30 is roughly in the shape of [symbol] and an air outlet 31 and air inlet 32 are configured on the two sides of the enclosure 30, respectively. Inside the enclosure 30, there is space to house the stator 10 and the rotor 20.

The stator 10 is housed at a preset location in the space of the enclosure 30. The center of the stator 10 is configured with a raised axial tube unit 11, which is in the shape of a tube with upward opening end. Inside the axial tube unit 11, there is a bearing 12. In addition, on the stator 10, there is a magnetic pole 13, which may be made up of magnetic inductive coils.

A preset fan A1 is configured on the periphery of the rotor 20. The fan Al is aligned to the air outlet 31 of the enclosure 30 for heat radiation and diversion of airflow. On the inner margin of the rotor 20, a magnetic ring 21 is configured to correspond to the magnetic pole 13 of the stator 10. At the center of the rotor 20, there is a magnetic inductive shaft 22. The shaft 22 is fitted in the axle hole 120 of the bearing 12. The input electric current enables the rotor 20 to revolve. In addition, the bottom section of the axial tube unit 11 is configured with a magnetic attraction component 40.

The magnetic attraction component 40 is comprised of a magnetic ring 41, at least one magnetic inductive bottom board 42, and at least on magnetic inductive ring 43.

The magnetic ring 41 is made of magnetic material with a ring hole 410 configured at the center. The ring hole 410 can allow the bottom section 221 of the shaft 22 to go through.

The magnetic inductive bottom board 42 is made of highly abrasion-resistant metal magnetic inductive board. The magnetic inductive bottom board 42 is configured at the bottom of the magnetic ring 41. The top surface of the magnetic inductive bottom board 42 can support the bottom end 121 of the shaft 22. With its high resistance to abrasion, it can bear the abrasion of the bottom end 121 of the shaft 22 for a longer period while maintaining a level surface status.

The magnetic inductive ring 43 is made of metal and fitted between the top of the magnetic ring 41 and the bottom end 121 of the bearing 12 with aligned top and bottom. The magnetic inductive ring 43 is configured with a through hole 430 at the center. The through hole 430 can allow the bottom section 221 of the shaft 22 to go through.

The above-mentioned structure constitutes the present invention. The operation of the present invention is described herein.

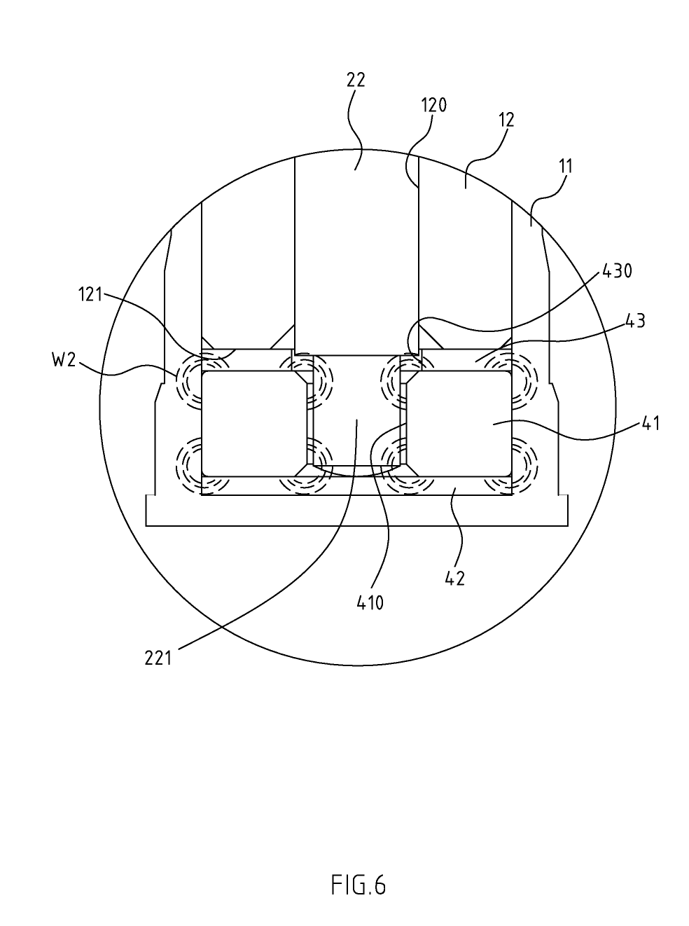

When the input electric current enables the rotor 20 to rotate, the shaft 22 configured at the center of the rotor 20 will rotate along with the bearing 12. The bottom section 221 of the shaft 22 is pivoted on the magnetic attraction component 40, which generates an axial attraction force to stabilize the rotor 20 and to avoid axial vibration during operation. Moreover, a magnetic inductive ring 43 and a magnetic inductive bottom board 42 of metal material are configured respectively on the top and bottom of the magnetic ring 41, so that the magnetic field W2 of the magnetic ring 41 is guided to the magnetic inductive ring 43 and the magnetic inductive bottom board 42 on the top and bottom respectively. The magnetic field W2 of the magnetic ring 41 is effectively suppressed or reduced. Referring to FIG. 6, the magnetic field W2 is evenly distributed within the preset range on the top, bottom and periphery, so that the range of the magnetic field W2 is minimized. Consequently, interference with other components is minimized within the cooling fan A, such as the Holtz component. In addition, as the magnetic inductive bottom board 42 is comprised of metal material with a higher degree of hardness than the magnetic inductive ring 43, the magnetic inductive bottom board 42 can bear the abrasion of the bottom end 121 of the shaft 22 for a longer period while maintaining a level surface status.

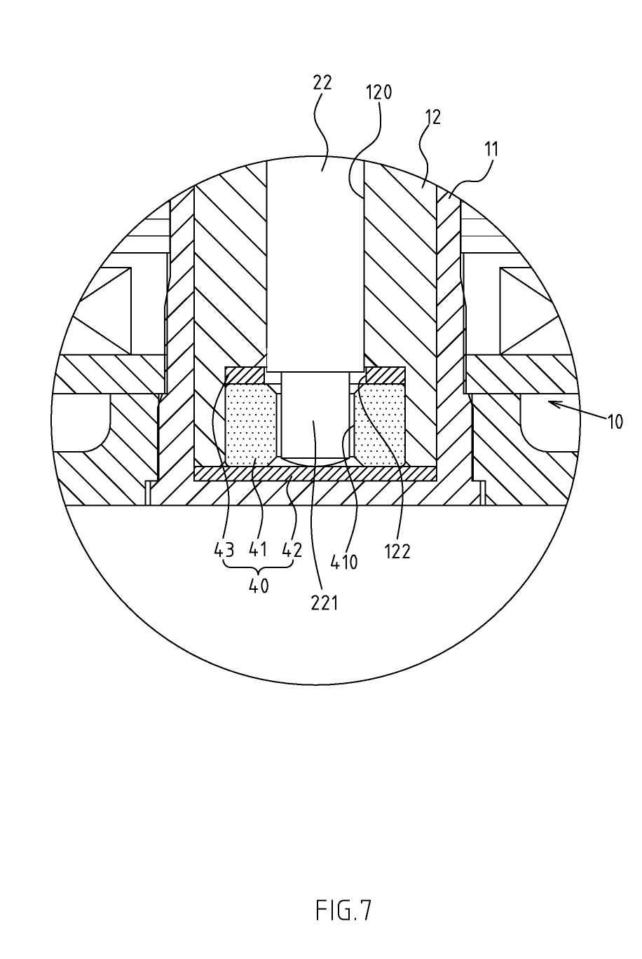

FIG. 7 shows another embodiment of the present invention. It is mainly an alternative embodiment with a relatively changed assembly structure of the bearing 12 and the magnetic attraction component 40. The bottom end 121 of the bearing 12 leans against the top surface of the magnetic inductive bottom board 42, so that the bottom section 221 of the axle hole 120 of the bearing 12 can have an expanded hole section 121 for fitting the magnetic ring 41 and the magnetic inductive ring 43. In this way, when the rotor 20 drives the shaft 22 to rotate, the bottom section 221 of the shaft 22 is positioned through axial attraction relative to the magnetic attraction component 40. As the magnetic field W2 of the magnetic ring 41 is guided to the magnetic inductive ring 43 and the magnetic inductive bottom board 42 on the top and bottom, it can also be effectively suppressed.

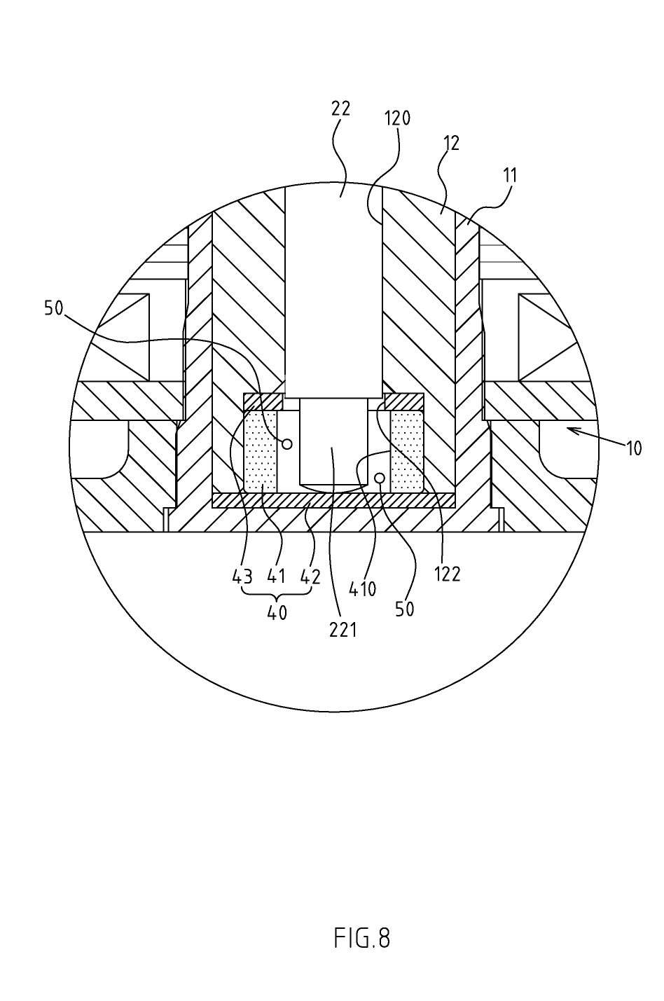

Now referring to FIG. 8, between the ring hole 410 of the magnetic ring 41 and the bottom section 221 of the shaft 22, a preset ring-shaped space is configured to form the oil storage space 50. The oil storage space 50 can store the oil that lubricates the bearing 12, so as to maintain a long lubrication effect.

1. A magnetic shaft of a cooling fan, said cooling fan having a stator, a rotor and an enclosure, said stator having a configured with a raised axial tube part, housing a bearing, said stator having a top configured with a magnetic pole, said rotor having a magnetic ring aligned with a magnetic pole of said stator, and a magnetic inductive shaft pivoted in an axle hole of said bearing the axial tube part having a bottom section configured with a magnetic attraction component, said magnetic attraction component being said magnetic shaft and comprising:
a magnetic ring with a ring hole at a center of a bottom section of the shaft to go through;
at least one magnetic inductive bottom board configured at a bottom of said magnetic ring, said magnetic inductive bottom board having a top supporting the shaft bottom end in a pivotal manner; and
at least one magnetic inductive ring configured on a top of said magnetic ring, said magnetic inductive ring having a through hole at a center for a shaft bottom section to go through.

2. The structure defined in claim 1, wherein the bottom end of the bearing leans on a top surface of said magnetic inductive ring.

3. The structure defined in claim 1, wherein the bottom end of the bearing leans on a top surface of said magnetic inductive bottom board; and wherein axle hole bottom section of the bearing is configured with a section with an expanded hole for fitting magnetic rings and the magnetic inductive rings.

4. The structure defined in claim 1, wherein said ring hole and said shaft bottom section is configured into a predetermined ring-shaped space the ring hole, said shaft bottom section of said magnetic ring so as to form an oil storage space.
